(19) United States
(12) Patent Application Publication
(10) Pub. No.: US 2022/0322243 A1
(43) Pub. Date: Oct. 6, 2022

(54) POWER CONTROL FOR MULTIPLEXING UPLINK CONTROL INFORMATION

(71) Applicant: QUALCOMM Incorporated, San Diego, CA (US)

(72) Inventors: Yi HUANG, San Diego, CA (US); Wei YANG, San Diego, CA (US)

(21) Appl. No.: 17/651,508

(22) Filed: Feb. 17, 2022

Related U.S. Application Data
(60) Provisional application No. 63/171,456, filed on Apr. 6, 2021.

(51) Int. Cl. H04W 52/32; H04W 72/04; H04W 72/10

(52) U.S. Cl. CPC H04W 52/325; H04W 72/0413; H04W 72/10

(57) ABSTRACT

Techniques described herein provide multiplexing of multiple forms of uplink control information (UCI) associated with different priorities on a single physical uplink control channel (PUCCH). For example, some techniques and apparatuses described herein provide multiplexing of the multiple forms of UCI as if they are associated with the same priority. Furthermore, some techniques and apparatuses described herein provide power control for the transmission of multiple forms of UCI on a single PUCCH. For example, a UE may apply a payload size dependent power boost for power control of a PUCCH based at least in part on the PUCCH carrying multiple forms of UCI. Still further, some techniques and apparatuses described herein provide a fallback technique where the UE is associated with insufficient power headroom to apply the payload size dependent power boost.

### CROSS-REFERENCE TO RELATED APPLICATION

This patent application claims priority to U.S. Provisional Patent Application No. 63/171,456, filed on Apr. 6, 2021, entitled “POWER CONTROL FOR MULTIPLEXING UPLINK CONTROL INFORMATION,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for power control for multiplexing uplink control information (UCI).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or forward link) refers to the communication link from the BS to the UE, and “uplink” (or reverse link) refers to the communication link from the UE to the BS. As will be described in more detail herein, a BS may be referred to as a Node B, a gNB, an access point (AP), a radio head, a transmit receive point (TRP), a 5G BS, a 5G Node B, or the like. A base station can be implemented in a disaggregated fashion, using a central unit (CU), one or more distributed units (DUs), and one or more radio units (RUs),

The above multiple access technologies have been adopted in various telecommunication standards to provide a common protocol that enables different wireless communication devices to communicate on a municipal, national, regional, and even global level. 5G, which may also be referred to as New Radio (NR), is a set of enhancements to the LTE mobile standard promulgated by the 3GPP. 5G is designed to better support mobile broadband Internet access by improving spectral efficiency, lowering costs, improving services, making use of new spectrum, and better integrating with other open standards using OFDM with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and 5G technologies. Preferably, these improvements should be applicable to other multiple access technologies and the telecommunication standards that employ these technologies.

### SUMMARY

A UE may provide uplink control information (UCI) to facilitate network operations associated with the UE. Examples of UCI include scheduling requests (SRs), hybrid automatic repeat request (HARQ) feedback (such as a HARQ acknowledgment (ACK)/negative ACK (NACK) (ACK/NACK)), and channel state information reporting. UCI may be transmitted via a physical uplink control channel (PUCCH). A PUCCH may be associated with a PUCCH format, which may include a short PUCCH format (which occupies one or two OFDM symbols) or a long PUCCH format (which occupies 4-14 symbols). In some cases, multiple forms of UCI may be scheduled for transmission on a single PUCCH resource, such as via a single PUCCH. Traditionally, such an overlap is handled by reference to priorities of the multiple forms of UCI. For example, a lower-priority UCI may be dropped so that a higher-priority UCI can be transmitted on the PUCCH. However, the dropping of UCI may lead to inefficient resource usage, increased latency, and violated quality of service (QoS) requirements for UCI.

Techniques and apparatuses described herein provide multiplexing of multiple forms of UCI associated with different priorities on a single PUCCH. For example, some techniques and apparatuses described herein provide multiplexing of the multiple forms of UCI as if they are associated with the same priority. In this way, latency is reduced relative to dropping a lower-priority form of UCI for the PUCCH, which may facilitate communication for low latency services such as ultra-reliable low latency communication (URLLC). Furthermore, some techniques and apparatuses described herein provide power control for the transmission of multiple forms of UCI on a single PUCCH. For example, a UE may apply a payload size dependent power boost for power control of a PUCCH based at least in part on the PUCCH carrying multiple forms of UCI. Applying the power boost improves the performance and reliability of the UCI, which facilitates multiplexing of the PUCCH without loss of reliability and which improves performance for reliable communications such as URLLC. Still further, some techniques and apparatuses described herein provide a fallback technique where the UE is associated with insufficient power headroom to apply the payload size dependent power boost. In this way, conformance with UE capabilities and power limitations is improved, which improves the versatility of PUCCH transmission and enables the usage of the techniques described herein by lower-capability UEs.

In some aspects, a method of wireless communication performed by a UE includes generating a payload carrying first UCI associated with a first priority level and second UCI associated with a second priority level different than the first priority level; and transmitting an uplink control channel communication carrying the payload using a power control parameter associated with the payload carrying both of the first UCI and the second UCI, wherein the power control parameter is based at least in part on a size of the payload.

In some aspects, a method of wireless communication performed by a UE includes generating, if the UE has sufficient transmit power headroom to use a power control parameter associated with payloads carrying both of first UCI and second UCI, a payload carrying first UCI associated with a first priority level and second UCI associated with a second priority level different than the first priority level; and transmitting an uplink control channel communication carrying the payload using the power control parameter associated with payloads carrying both of the first UCI and the second UCI, wherein the power control parameter is based at least in part on a size of the payload.

In some aspects, a method of wireless communication performed by a base station includes configuring a UE with a power control parameter for a payload carrying first UCI associated with a first priority level and second UCI associated with a second priority level different than the first priority level, wherein the power control parameter is based at least in part on a size of the payload; and receiving an uplink control channel communication from the UE carrying the payload.

In some aspects, an apparatus of a UE for wireless communication includes a memory; and one or more processors, coupled to the memory, configured to: generate a payload carrying first UCI associated with a first priority level and second UCI associated with a second priority level different than the first priority level; and transmit an uplink control channel communication carrying the payload using a power control parameter associated with the payload carrying both of the first UCI and the second UCI, wherein the power control parameter is based at least in part on a size of the payload.

In some aspects, an apparatus of a UE for wireless communication includes a memory; and one or more processors, coupled to the memory, configured to: generate, if the UE has sufficient transmit power headroom to use a power control parameter associated with payloads carrying both of first UCI and second UCI, a payload carrying first UCI associated with a first priority level and second UCI associated with a second priority level different than the first priority level; and transmit an uplink control channel communication carrying the payload using the power control parameter associated with payloads carrying both of the first UCI and the second UCI, wherein the power control parameter is based at least in part on a size of the payload.

In some aspects, an apparatus of a network entity (e.g., base station) for wireless communication includes a memory; and one or more processors, coupled to the memory, configured to: configure a UE with a power control parameter for a payload carrying first UCI associated with a first priority level and second UCI associated with a second priority level different than the first priority level, wherein the power control parameter is based at least in part on a size of the payload; and receive an uplink control channel communication from the UE carrying the payload.

In some aspects, a non-transitory computer-readable medium storing a set of instructions for wireless communication includes one or more instructions that, when executed by one or more processors of a UE, cause the UE to: generate a payload carrying first UCI associated with a first priority level and second UCI associated with a second priority level different than the first priority level; and transmit an uplink control channel communication carrying the payload using a power control parameter associated with the payload carrying both of the first UCI and the second UCI, wherein the power control parameter is based at least in part on a size of the payload.

In some aspects, a non-transitory computer-readable medium storing a set of instructions for wireless communication includes one or more instructions that, when executed by one or more processors of an UE, cause the UE to: generate, if the UE has sufficient transmit power headroom to use a power control parameter associated with payloads carrying both of first UCI and second UCI, a payload carrying first UCI associated with a first priority level and second UCI associated with a second priority level different than the first priority level; and transmit an uplink control channel communication carrying the payload using the power control parameter associated with payloads carrying both of the first UCI and the second UCI, wherein the power control parameter is based at least in part on a size of the payload.

In some aspects, a non-transitory computer-readable medium storing a set of instructions for wireless communication includes one or more instructions that, when executed by one or more processors of a base station, cause the base station to: configure a UE with a power control parameter for a payload carrying first UCI associated with a first priority level and second UCI associated with a second priority level different than the first priority level, wherein the power control parameter is based at least in part on a size of the payload; and receive an uplink control channel communication from the UE carrying the payload.

In some aspects, an apparatus for wireless communication includes means for generating a payload carrying first UCI associated with a first priority level and second UCI associated with a second priority level different than the first priority level; and means for transmitting an uplink control channel communication carrying the payload using a power control parameter associated with the payload carrying both of the first UCI and the second UCI, wherein the power control parameter is based at least in part on a size of the payload.

In some aspects, an apparatus for wireless communication includes means for generating, if the UE has sufficient transmit power headroom to use a power control parameter associated with payloads carrying both of first UCI and second UCI, a payload carrying first UCI associated with a first priority level and second UCI associated with a second priority level different than the first priority level; and means for transmitting an uplink control channel communication carrying the payload using the power control parameter associated with payloads carrying both of the first UCI and the second UCI, wherein the power control parameter is based at least in part on a size of the payload.

In some aspects, an apparatus for wireless communication includes means for configuring a UE with a power control parameter for a payload carrying first UCI associated with a first priority level and second UCI associated with a second priority level different than the first priority level, wherein the power control parameter is based at least in part on a size of the payload; and means for receiving an uplink control channel communication from the UE carrying the payload.

Aspects generally include a method, apparatus, system, computer program product, non-transitory computer-readable medium, user equipment, base station, wireless communication device, and/or processing system as substantially described with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

FIG. 1 is diagram illustrating an example of a wireless network, in accordance with the present disclosure.

FIG. 2 is a diagram illustrating an example of a base station in communication with a UE in a wireless network, in accordance with the present disclosure.

FIG. 3 is a diagram illustrating examples of multiplexing multiple forms of UCI associated with different priority levels on a single PUCCH, in accordance with the present disclosure.

FIG. 4 is a diagram illustrating an example of generation and transmission of a PUCCH payload incorporating first UCI and second UCI with different priorities, in accordance with the present disclosure.

FIG. 5 is a diagram illustrating an example of generation and transmission of a PUCCH payload incorporating first UCI and second UCI with different priorities, in accordance with the present disclosure.

FIG. 6 is a diagram illustrating an example of generation and transmission of a PUCCH payload incorporating first UCI and second UCI with different priorities, in accordance with the present disclosure.

FIGS. 7-9 are flowcharts of example methods of wireless communication, in accordance with the present disclosure.

FIG. 10 is a block diagram of an example apparatus for wireless communication, in accordance with the present disclosure.

FIG. 11 is a diagram illustrating an example of a hardware implementation for an apparatus employing a processing system, in accordance with the present disclosure.

FIG. 12 is a block diagram of an example apparatus for wireless communication, in accordance with the present disclosure.

FIG. 13 is a diagram illustrating an example of a hardware implementation for an apparatus employing a processing system, in accordance with the present disclosure.

### DETAILED DESCRIPTION

The detailed description set forth below in connection with the appended drawings is intended as a description of various configurations and is not intended to represent the configurations in which the concepts described herein may be practiced. The detailed description includes specific details for the purposes of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, or the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, or the like, whether referred to as software, firmware, middleware, microcode, hardware description language, or otherwise.

Accordingly, in one or more example embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

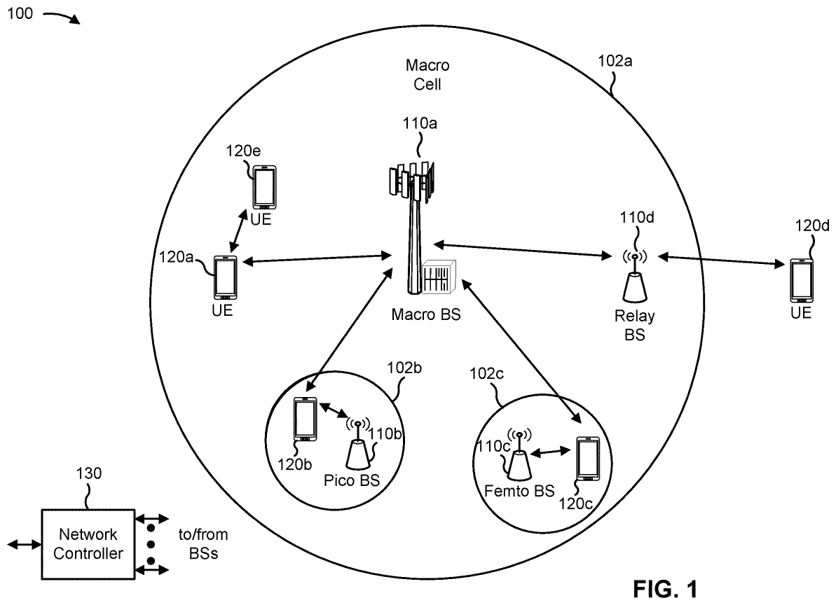

FIG. 1 is a diagram illustrating a wireless network 100 in which aspects of the present disclosure may be practiced. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as a 5G BS, a Node B, a gNB, a 5G NB, an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

ABS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “5G BS”, “gNB”, “TRP”, “AP”, “node B”, “5G NB”, and “cell” may be used interchangeably herein.

In some examples, a cell may not necessarily be stationary, and the geographic area of the cell may move according to the location of a mobile BS. In some examples, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, etc. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, etc., that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, or the like.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a BS, or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

As indicated above, FIG. 1 is provided as an example. Other examples may differ from what is described with regard to FIG. 1.

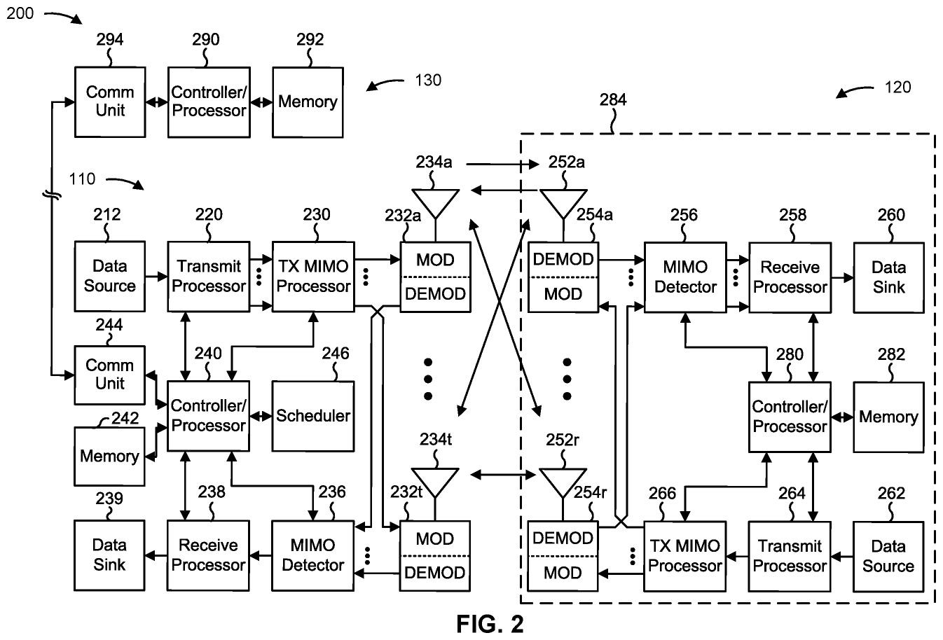

FIG. 2 is a diagram illustrating an example 200 of a base station 110 in communication with a UE 120 in a wireless network 100. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, may select a modulation and coding scheme (MCS) for each UE based at least in part on channel quality indicators (CQIs) received from the UE, process (e.g., encode and modulate) the data for each UE based at least in part on the MCS selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS), a phase tracking reference signal (PTRS), and/or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive (RX) processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein. A scheduler 246 may schedule UEs for data transmission on the downlink and/or uplink.

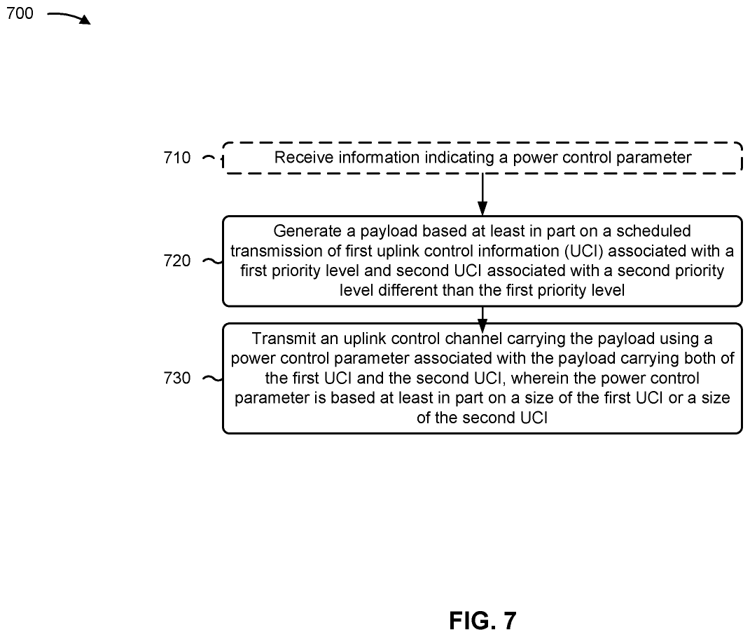

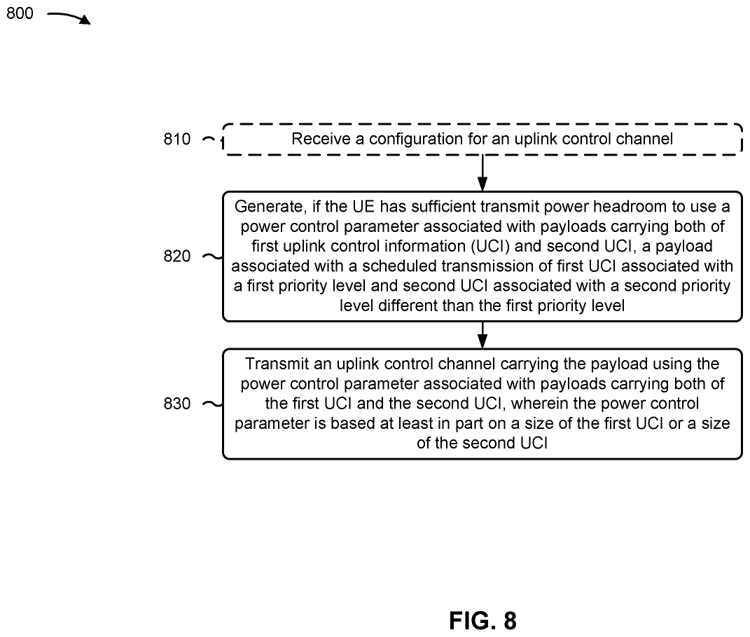

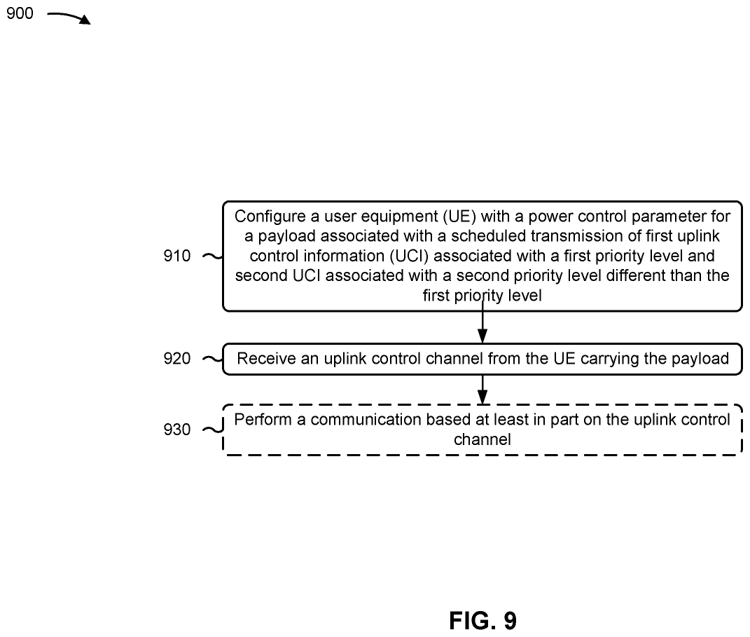

Controller/processor 240 of base station 110, controller/processor 280 of UE 120, and/or any other component(s) of FIG. 2 may perform one or more techniques associated with power control for multiplexing uplink control information (UCI), as described in more detail elsewhere herein. For example, controller/processor 240 of base station 110, controller/processor 280 of UE 120, and/or any other component(s) of FIG. 2 may perform or direct operations of, for example, method 700 of FIG. 7, method 800 of FIG. 8, method 900 of FIG. 9, and/or other processes as described herein. Memories 242 and 282 may store data and program codes for BS 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, method 700 of FIG. 7, method 800 of FIG. 8, method 900 of FIG. 9, and/or other processes as described herein. In some aspects, executing instructions may include running the instructions, converting the instructions, compiling the instructions, and/or interpreting the instructions, among other examples.

As indicated above, FIG. 2 is provided as an example. Other examples may differ from what is described with regard to FIG. 2.

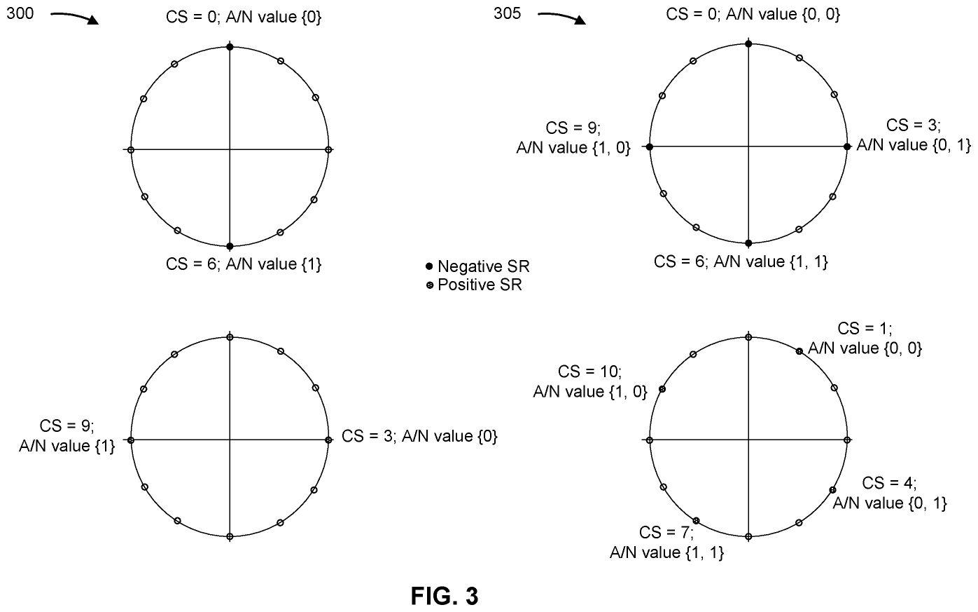

FIG. 3 is a diagram illustrating examples 300 and 305 of multiplexing multiple forms of UCI associated with different priority levels on a single PUCCH, in accordance with the present disclosure. Examples 300 and 305 relate to a plurality of cyclic shift (CS) positions of a base sequence S. For example, each of the larger circles of example 300 and 305 illustrate 12 CS positions: CS=0 through CS=11. Thus, the base sequence S can be transmitted with one of the 12 CS positions via a PUCCH, thereby indicating some form of information. A smaller circle indicates a CS position of the base sequence S. A shaded or filled smaller circle indicates that that CS position can be used to indicate a UCI value. For example, a base station may configure a UE to transmit a PUCCH with a particular CS position to indicate a certain hybrid automatic repeat request (HARQ) feedback value, a particular scheduling request (SR) state (that is, positive SR or negative SR), or the like. Thus, the UE can be configured with different subsets of CS positions to indicate different combinations of HARQ feedback and SR states. The configuration and/or usage of a CS position to indicate a combination of HARQ feedback and an SR state is referred to herein as “multiplexing HARQ feedback and an SR.”

A UE may multiplex HARQ feedback and an SR in a PUCCH using a CS position, as described below. For example, the HARQ feedback and the SR may be associated with different priorities. By multiplexing the HARQ feedback and the SR in a PUCCH despite the HARQ feedback and the SR having different priorities, the UE reduces latency and improves efficiency of PUCCH reporting. Furthermore, by applying a power control parameter that provides for a power boost when the HARQ feedback and the SR are multiplexed, the UE improves reliability and performance of the reporting of HARQ feedback and SRs.

Example 300 shows how a one-bit HARQ feedback value can be multiplexed with an indication of an SR. As shown at the top left corner of FIG. 3, for a negative SR, a first CS position (CS=0) may be configured to indicate a HARQ feedback value (that is, an ACK/NACK (A/N)) value of 0 and a negative SR. Furthermore, a seventh CS position (CS=6) may be configured to indicate a HARQ feedback value of 1 and a negative SR. As shown at the bottom left corner of FIG. 3, for a positive SR, a fourth CS position (CS=3) may be configured to indicate a HARQ feedback value of 0 and a positive SR. Furthermore, a tenth CS position (CS=9) may be configured to indicate a HARQ feedback value of 1 and a positive SR.

Example 305 shows how a two-bit HARQ feedback value can be multiplexed with an indication of an SR. As shown at the top right corner of FIG. 3, for a negative SR, a first CS position (CS=0) may be configured to indicate a HARQ feedback value (that is, an ACK/NACK (A/N)) value of {0, 0} and a negative SR. Furthermore, a fourth CS position (CS=3) may be configured to indicate a HARQ feedback value of {0, 1} and a negative SR. Furthermore, a seventh CS position (CS=6) may be configured to indicate a HARQ feedback value of {1, 1} and a negative SR. Furthermore, a tenth CS position (CS=6) may be configured to indicate a HARQ feedback value of {1, 0} and a negative SR.

As shown at the bottom right corner of FIG. 3, for a positive SR, a second CS position (CS=1) may be configured to indicate a HARQ feedback value (that is, an ACK/NACK (A/N)) value of {0, 0} and a positive SR. Furthermore, a fifth CS position (CS=4) may be configured to indicate a HARQ feedback value of {0, 1} and a positive SR. Furthermore, an eighth CS position (CS=7) may be configured to indicate a HARQ feedback value of {1, 1} and a positive SR. Furthermore, an eleventh CS position (CS=10) may be configured to indicate a HARQ feedback value of {1, 0} and a positive SR.

The above examples of mappings between CS positions, HARQ feedback states, and SR states are provided as examples, and the mapping with which a UE is configured may differ from the above.

HARQ feedback indicates whether a corresponding communication is received. For example, a communication (such as a transport block) may be associated with a HARQ process and a mapping to a feedback resource. The UE may determine whether the communication is successfully received and may provide an ACK on the resource if the communication is successfully received or a NACK if the communication is not successfully received. In some cases, the UE may provide multi-bit HARQ feedback, which may provide feedback regarding multiple communications or multiple parts of a communication.

An SR indicates that a UE requests uplink resources for a transmission by the UE. The UE may transmit an SR based at least in part on determining to perform an uplink transmission. A positive SR indicates that the UE requests uplink resources, whereas a negative SR indicates that the UE does not request uplink resources.

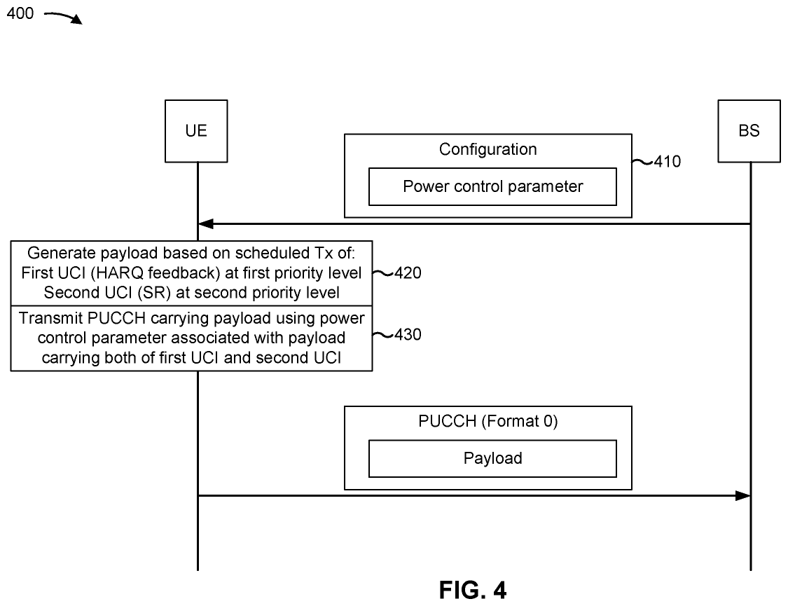

FIG. 4 is a diagram illustrating an example 400 of generation and transmission of a PUCCH payload incorporating first UCI and second UCI with different priorities, in accordance with the present disclosure. Example 400 includes a UE (e.g., UE 120) and a BS (e.g., BS 110).

At 410, the BS may transmit a configuration to the UE. For example, the BS may transmit configuration information, such as via radio resource control (RRC) signaling, medium access control (MAC) signaling, downlink control information (DCI), a combination thereof, or the like. In some aspects, the BS may transmit the configuration as part of connection establishment with the UE, via a system information broadcast, as part of configuration of the UE, or the like. In some aspects, the configuration may indicate a configuration for multiplexing different forms of UCI, such as a subset of CS positions for multiplexing different forms of UCI, as described with regard to FIG. 3.

As shown, in some aspects, the configuration may indicate a power control parameter. The power control parameter may include a parameter used by the UE to determine a transmit power for a PUCCH. For example, the power control parameter may be for determining a transmit power for the PUCCH based at least in part on the PUCCH including first UCI and second UCI (such as multiplexed UCI, which may be at different priority levels). In some aspects, the power control parameter may provide a payload size dependent power boost for power control of the PUCCH. By providing for a payload size dependent power boost, the reliability of higher priority UCI is improved when the higher priority UCI is multiplexed with lower priority UCI, as described below.

In some aspects, the power control parameter may be based at least in part on a variable Δ_{UCI}(i). For example, the power control parameter may indicate how to determine Δ_{UCI}(i) if multiple forms of UCI are multiplexed onto a single PUCCH. In some aspects, the power control parameter may be for a PUCCH format, such as a short PUCCH format (e.g., PUCCH Format 0 or PUCCH Format 1, according to 5G specifications). As an example, the power control parameter may define Δ_{UCI}(i) in the form:

$${Δ}_{UCI} ( i ) = \{ \begin{matrix}{Δ}_{UCI}^{LP , 1} \\ {Δ}_{UCI}^{LP , 2} \\ {Δ}_{UCI}^{HP , 1} \\ {Δ}_{UCI}^{HP , 2}\end{matrix} ,$$

wherein Δ_{UCI}(i) is based at least in part on whether a multiplexed payload is transmitted in a resource block associated with a higher-priority UCI or a lower-priority UCI, and whether a lower-priority UCI or a higher-priority UCI is multiplexed on the resource block. For example, Δ_{UCI}^{LP,1} may be used for a payload transmitted in a higher-priority UCI's resource block (such as based at least in part on the higher-priority UCI's baseline power control) and may provide for a power boost (that is, an increased transmit power relative to a value of Δ_{UCI}(i) of 0) to account for a one-bit UCI of lower priority multiplexed in the higher-priority UCI's resource block. For example, Δ_{UCI}^{LP,2} may be used for a payload transmitted in a higher-priority UCI's resource block (such as based at least in part on the higher-priority UCI's baseline power control) and may provide for a power boost (that is, an increased transmit power relative to a value of Δ_{UCI}(i) of 0) to account for a two-bit UCI of lower priority multiplexed in the higher-priority UCI's resource block. For example, Δ_{UCI}^{HP,1} may be used for a payload transmitted in a lower-priority UCI's resource block (such as based at least in part on the lower-priority UCI's baseline power control) and may provide for a power boost (that is, an increased transmit power relative to a value of Δ_{UCI}(i) of 0) to account for a one-bit UCI of higher priority multiplexed in the lower-priority UCI's resource block. For example, Δ_{UCI}^{HP,2} may be used for a payload transmitted in a lower-priority UCI's resource block (such as based at least in part on the lower-priority UCI's baseline power control) and may provide for a power boost (that is, an increased transmit power relative to a value of Δ_{UCI}(i) of 0) to account for a two-bit UCI of higher priority multiplexed in the lower-priority UCI's resource block. In some aspects, each of the above parameters for Δ_{UCI}(i) may have different values from each other. In some aspects, two or more of the above parameters for Δ_{UCI}(i) may have the same value. In some aspects, the values of Δ_{UCI}^{HP,1} and/or Δ_{UCI}^{HP,2} may be larger than the values of Δ_{UCI}^{LP,1} and/or Δ_{UCI}^{LP,2}, such that a larger power boost is applied when higher-priority UCI is multiplexed onto a lower-priority UCI's resource block. It can be seen that the power control parameter is based at least in part on a size of the payload, since the power control parameter is based at least in part on whether a one-bit or a two-bit channel is multiplexed onto a resource block of another channel.

At 420, the UE may generate a payload for a PUCCH. For example, the UE may generate an uplink shared channel (UL-SCH). As shown, the payload may be based at least in part on a scheduled transmission of first UCI and second UCI. In some examples, the payload may carry the first UCI and the second UCI. In some other examples, the payload may carry only part of (or may not carry) the first UCI or the second UCI. The first UCI may be associated with a first priority level, and the second UCI may be associated with a second priority level. In some aspects, the first priority level is higher than the second priority level (meaning that the first UCI is prioritized over the second UCI). In other aspects, the first priority level is lower than the second priority level. In example 400, the first UCI carries HARQ feedback (such as one-bit HARQ feedback or two-bit HARQ feedback), and the second UCI carries an SR (such as a one-bit SR), though in some cases, the first UCI and/or the second UCI may carry a different form of UCI. In some aspects, the first UCI and the second UCI may carry the same form of UCI and may be associated with different priority levels. The UE may generate the payload including the first UCI and the second UCI based at least in part on the first UCI and the second UCI being associated with the same PUCCH resource. For example, HARQ feedback may be associated with a HARQ resource that indicates where the HARQ feedback is to be transmitted. In example 400, the HARQ resource is a same resource used to transmit the SR.

At 430, the UE may transmit the payload. For example, the UE may transmit the payload using the power control parameter described above at 430. In some aspects, the UE may perform power control for the transmission of the payload. For example, the UE may determine a transmit power for a PUCCH carrying the payload using the power control parameter based at least in part on a power control formula of the form shown below:

$${P}_{PUCCH , b , f , c} ( i , {q}_{u} , {q}_{d} , l ) = min \{ \begin{matrix}{P}_{CMAX , f , c} ( i ) , \\ {P}_{O\_PUCCH , b , f , c} ( {q}_{u} ) + 10 {log}_{10} ( {2}^{μ} \cdot {M}_{RB , b , f , c}^{PUCCH} ( i ) ) + \\ {PL}_{b , f , c} ( {q}_{d} ) + {Δ}_{F\_PUCCH} ( F ) + {Δ}_{TF , b , f , c} ( i ) + {g}_{b , f , c} ( i , l )\end{matrix} \}$$

In the above formula, P_{PUCCH,b,f,c}(i, qᵤ, q_{d}, l) indicates a transmit power. P_{CMAX,f,c}(i) is the maximum transmit power allowed at the UE. P_{O_PUCCH,b,f,c}(qᵤ) is an open-loop power control parameter configured by the network. M_{RB,b,f,c}^{PUCCH}(i)) is the number of resource blocks of the PUCCH (where μ is a subcarrier spacing). PL_{b,f,c}(q_{d}) is a pathloss measurement based at least in part on a downlink power control reference signal. Δ_{F_PUCCH}(F) is an offset related to the PUCCH format. g_{b,f,c}(i,l) is a dynamic power control command. Δ_{TF,b,f,c}(i) may be determined as follows (note that Δ_{TF,b,f,c}(i) takes into account the power control parameter Δ_{UCI}(i) configured at 410):

$${Δ}_{TF , b , f , c} ( i ) = 10 {log}_{10} ( \frac{{N}_{ref}^{PUCCH}}{{N}_{symb}^{PUCCH} ( i )} ) + {Δ}_{UCI} ( i )$$

In this way, the base station configures, and the UE uses, an increased transmit power for a PUCCH with a multiplexed payload including a higher-priority UCI and a lower-priority UCI, which improves the reliability of reception of the PUCCH.

As indicated above, FIG. 4 is provided as an example. Other examples may differ from what is described with regard to FIG. 4.

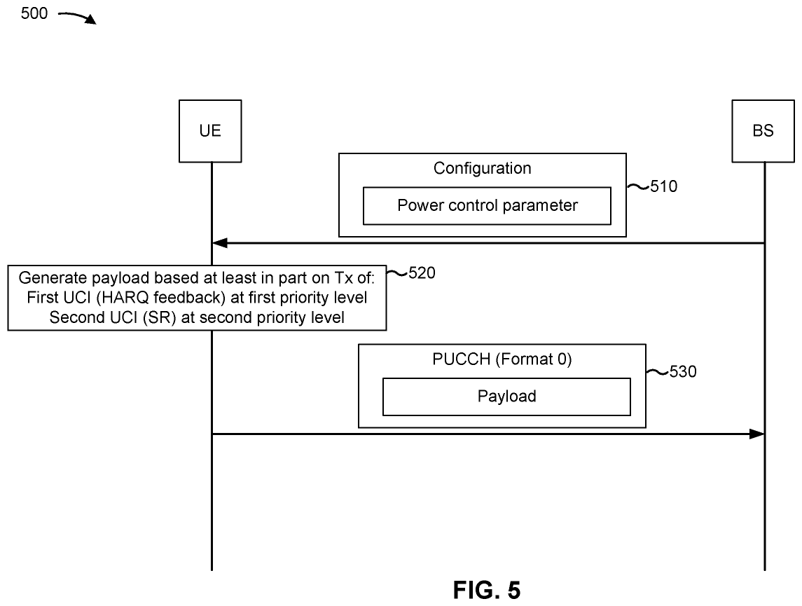

FIG. 5 is a diagram illustrating an example 500 of generation and transmission of a PUCCH payload incorporating first UCI and second UCI with different priorities, in accordance with the present disclosure. Example 500 includes a UE (e.g., UE 120) and a BS (e.g., BS 110).

At 510, the BS may transmit a configuration to the UE. For example, the BS may transmit configuration information, such as via RRC signaling, MAC signaling, DCI, a combination thereof, or the like. In some aspects, the BS may transmit the configuration as part of connection establishment with the UE, via a system information broadcast, as part of configuration of the UE, or the like. In some aspects, the configuration may indicate a configuration for multiplexing different forms of UCI, such as a subset of CS positions for multiplexing different forms of UCI, as described with regard to FIG. 3.

At 520, the UE may generate a payload for a PUCCH. As shown, the payload may be based at least in part on a scheduled transmission of first UCI and second UCI. The first UCI may be associated with a first priority level, and the second UCI may be associated with a second priority level. In some aspects, the first priority level is higher than the second priority level. In other aspects, the first priority level is lower than the second priority level. In example 500, the first UCI carries HARQ feedback (such as one-bit HARQ feedback or two-bit HARQ feedback) and the second UCI carries an SR (such as a one-bit SR), though in some cases, the first UCI and/or the second UCI may carry a different form of UCI. In some aspects, the first UCI and the second UCI may carry the same form of UCI and may be associated with different priority levels. The UE may generate the payload including the first UCI and the second UCI based at least in part on the first UCI and the second UCI being associated with the same PUCCH resource. For example, HARQ feedback may be associated with a HARQ resource that indicates where the HARQ feedback is to be transmitted. In example 500, the HARQ resource is a same resource used to transmit the SR.

At 530, the UE may transmit the payload. In some aspects, the UE may transmit the payload using a baseline transmit power, such as a transmit power determined using a Δ_{UCI}(0 value of 0. In other aspects, the UE may transmit the payload using the power control parameter described above at 430. In this way, multiplexing of UCI with different priority levels is enabled, which reduces latency and improves conformance with priority levels of UCI transmission.

As indicated above, FIG. 5 is provided as an example. Other examples may differ from what is described with regard to FIG. 5.

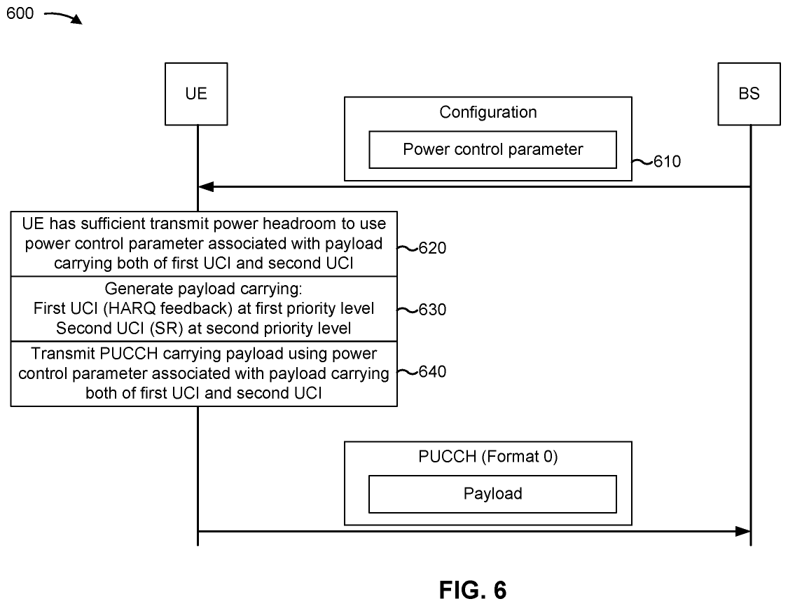

FIG. 6 is a diagram illustrating an example 600 of generation and transmission of a PUCCH payload incorporating first UCI and second UCI with different priorities, in accordance with the present disclosure. Example 600 includes a UE (e.g., UE 120) and a BS (e.g., BS 110). In example 600, the UE determines whether to multiplex the first UCI and the second UCI.

At 610, the BS may transmit a configuration to the UE. For example, the BS may transmit configuration information, such as via RRC signaling, MAC signaling, DCI, a combination thereof, or the like. In some aspects, the BS may transmit the configuration as part of connection establishment with the UE, via a system information broadcast, as part of configuration of the UE, or the like. In some aspects, the configuration may indicate a configuration for multiplexing different forms of UCI, such as a subset of CS positions for multiplexing different forms of UCI, as described with regard to FIG. 3. In some aspects, the configuration information may indicate a power control parameter, as described with regard to FIG. 4 at 410. In some aspects, the configuration information may indicate that the UE is to determine whether to multiplex the first UCI and the second UCI, such as based at least in part on whether the transmit power of the PUCCH, determined using the configured power control parameter, exceeds the maximum transmit power of the UE (e.g., P_{CMAX,f,c}(i)).

At 620, the UE may determine that the UE has sufficient transmit power headroom to use the power control parameter associated with the payload carrying both of the first UCI and the second UCI. For example, the UE may determine that a PUCCH carrying a payload in which the first UCI and the second UCI are multiplexed is associated with a transmit power (P_{PUCCH,b,f,c} (i, qᵤ, q_{d}, l)) that does not exceed P_{CMAX,f,c}(i) Thus, the UE may multiplex the first UCI and the second UCI. For example, at 630, the UE may generate the payload for the PUCCH. As shown, the payload may include first UCI and second UCI. The first UCI may be associated with a first priority level and the second UCI may be associated with a second priority level. In some aspects, the first priority level is higher than the second priority level. In other aspects, the first priority level is lower than the second priority level. In example 600, the first UCI carries HARQ feedback (such as one-bit HARQ feedback or two-bit HARQ feedback) and the second UCI carries an SR (such as a one-bit SR), though in some cases, the first UCI and/or the second UCI may carry a different form of UCI.

In some aspects, the UE may determine that the UE has insufficient transmit power headroom to use the power control parameter associated with the payload carrying both of the first UCI and the second UCI. For example, the UE may determine that a PUCCH carrying a payload in which the first UCI and the second UCI are multiplexed is associated with a transmit power (P_{PUCCH,b,f,c} (i, qᵤ, q_{d}, l)) that exceeds P_{CMAX,f,c}(i). In this case, in some aspects, the UE may drop a lower-priority UCI of the first UCI and the second UCI based at least in part on comparing priority levels of the first UCI and the second UCI, which reduces the transmit power of the UE to satisfy the transmit power headroom. In some aspects, the UE may partially drop one of the first UCI or the second UCI. For example, if the PUCCH with Δ_{UCI}(i)=Δ_{UCI}^{LP,1}<P_{CMAX,f,c}(i), the UE may drop 2 bits of the lower-priority UCI based at least in part on comparing priority levels of the first UCI and the second UCI. If the PUCCH with Δ_{UCI}(i)=Δ_{UCI}^{LP,1}>P_{CMAX,f,c}(i) and Δ_{UCI}(i)=Δ_{UCI}^{LP,2}<P_{CMAX,f,c}(i), then the UE may drop at least one bit of the lower-priority UCI based at least in part on comparing priority levels of the first UCI and the second UCI, or may compress the two bits of the lower-priority UCI into a single bit (such as by performing an AND operation for the two-bits of the lower-priority UCI to generate a compressed version of the UCI), then may multiplex the compressed version of the UCI with the higher-priority UCI onto the PUCCH. In some aspects, the UE may selectively generate the payload by dropping part of the second UCI to form the one or more bits, compress the second UCI to form the compressed version of the second UCI, or multiplex the first UCI and the second UCI, based at least in part on signaling from the BS, such as the configuration shown at 610, DCI signaling, or the like.

At 640, the UE may transmit the payload. For example, the UE may transmit the payload via a PUCCH using a short PUCCH format (here, PUCCH Format 0) using the power control parameter described above at 610. The UE may transmit a PUCCH communication (e.g., an uplink control channel communication) carrying the payload via the PUCCH. A short PUCCH format is a PUCCH format that occupies 1 or 2 OFDM symbols. A long PUCCH format is a PUCCH format that occupies 4 to 14 OFDM symbols. In some aspects, the UE may perform power control for the transmission of the payload. For example, the UE may determine a transmit power for a PUCCH carrying the payload using the power control parameter based at least in part on the power control formula described in FIG. 4. In this way, the base station configures, and the UE uses, an increased transmit power for a PUCCH with a multiplexed payload including a higher-priority UCI and a lower-priority UCI, which improves the reliability of reception of the PUCCH.

The base station may receive the payload. In some aspects, the base station may perform blind detection (which may include multiple hypothesis testing) to determine whether the UE compressed or trimmed the payload (such as using a hypothesis corresponding to a baseline payload, as well as one or more hypotheses corresponding to a modified payload such as a trimmed or compressed payload). In some aspects, the base station may determine whether to perform blind decoding based at least in part on signaling from the UE. For example, based at least in part on the UE's power headroom report, the base station may determine that the UE has reached (or is approach) a maximum power of the UE. If the UE's transmit power is still far from the maximum power (that is, if the UE reports a large power headroom), then the base station may assume that the UE will not compress or trim (e.g., drop one or more bits of) the payload, and/or may not perform blind decoding, thereby conserving blind decoding resources. If the UE's power has reached the maximum power (such as if the UE reports 0 or negative power headroom), the base station may determine that the UE will perform or has performed compression or trimming of the payload and/or may receive the payload without performing blind decoding, thereby conserving blind decoding resources. In a case wherein the UE's transmit power is close to the maximum power (such as when the UE report a power headroom that is lower than a threshold), then the base station may perform blind detection.

As indicated above, FIG. 6 is provided as an example. Other examples may differ from what is described with regard to FIG. 6.

FIG. 7 is a flowchart of an example method 700 of wireless communication, in accordance with the present disclosure. The method 700 may be performed by, for example, an UE (e.g., UE 120).

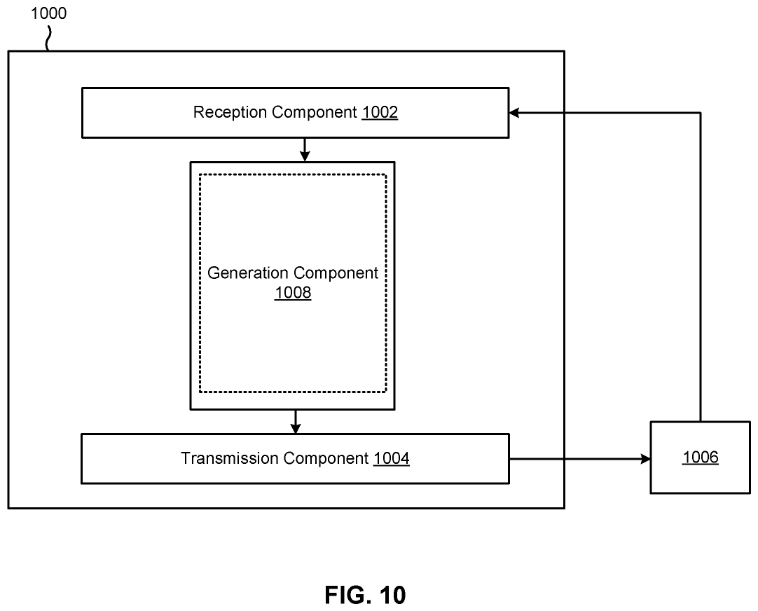

At 710, the UE may receive information indicating a power control parameter. For example, the UE (e.g., using reception component 1002, depicted in FIG. 10) may receive information indicating the power control parameter. In some aspects, this information may be a configuration, such as shown at 410, 510, and 610.

At 720, the UE may generate a payload based at least in part on a scheduled transmission of first UCI associated with a first priority level and second UCI associated with a second priority level different than the first priority level. For example, the UE (e.g., using generation component 1008, depicted in FIG. 10) may generate a payload. The payload may be based at least in part on a scheduled transmission of first UCI associated with a first priority level and second UCI associated with a second priority level different than the first priority level, as described above in connection with, for example, FIGS. 4, 5, and 6 at 420, 520, and 630. For example, the payload may include at least part of the first UCI and/or at least part of the second UCI.

In some aspects, generating the payload carrying the first UCI and the second UCI is based at least in part on the UE having sufficient transmit power headroom to use the power control parameter for the uplink control channel communication. In some aspects, if the UE does not have sufficient transmit power headroom to use the power control parameter for the uplink control channel communication, at least part of a UCI, of the first UCI and the second UCI, is dropped based at least in part on comparing the first priority level and the second priority level. In some aspects, generating the payload further comprises generating the payload including the first UCI and at least a part of the second UCI, wherein the at least a part of the second UCI comprises one or more bits of the second UCI or a compressed version of the second UCI. In some aspects, method 700 includes receiving signaling indicating whether to drop part of the second UCI to form the one or more bits or to compress the second UCI to form the compressed version of the second UCI. For example, the signaling may be received via a configuration, such as the configuration shown at 410, 510, or 610. In some aspects, method 700 includes receiving signaling indicating whether to generate the payload by dropping part of the second UCI to form the one or more bits, compressing the second UCI to form the compressed version of the second UCI, or multiplexing the first UCI and the second UCI. For example, the signaling may be received via a configuration, such as the configuration shown at 410, 510, or 610.

At 730, the UE may transmit an uplink control channel communication carrying the payload using a power control parameter associated with the payload carrying both of the first UCI and the second UCI, wherein the power control parameter is based at least in part on a size of the first UCI or a size of the second UCI. For example, the UE (e.g., using transmission component 1004, depicted in FIG. 10) may transmit an uplink control channel communication carrying the payload using a power control parameter associated with the payload carrying both of the first UCI and the second UCI. The power control parameter may be based at least in part on a size of the payload, such as a size of the first UCI and/or a size of the second UCI, as described above in connection with, for example, FIGS. 4, 5, and 6 and at 430, 530, and 640. In some aspects, the first UCI is a scheduling request, the second UCI is HARQ feedback, and the first priority level is higher than the second priority level. In some aspects, the first UCI is HARQ feedback, the second UCI is a scheduling request, and the first priority level is higher than the second priority level.

In some aspects, the power control parameter indicates a power boost for the uplink control channel communication relative to a baseline transmit power for the uplink control channel communication based at least in part on the size of the payload. In some aspects, the payload is transmitted in a resource block associated with the first UCI, and the power control parameter is based at least in part on a power level associated with the first UCI and a size of the second UCI. In some aspects, the power control parameter indicates a first power boost if the second UCI has a first size and a second power boost if the second UCI has a second size. In some aspects, the uplink control channel communication is associated with a short control channel format.

Although FIG. 7 shows example blocks of method 700, in some aspects, method 700 may include additional blocks, fewer blocks, different blocks, or differently arranged blocks than those depicted in FIG. 7. Additionally, or alternatively, two or more of the blocks of method 700 may be performed in parallel.

FIG. 8 is a flowchart of an example method 800 of wireless communication. The method 800 may be performed by, for example, a UE (e.g., UE 120).

At 810, the UE may optionally receive (e.g., using antenna 252, DEMOD 254, MIMO detector 256, receive processor 258, controller/processor 280, and/or the like) a configuration for an uplink control channel communication. The reception of the configuration is described in more detail in connection with FIG. 6.

At 820, the UE may generate, based at least in part on whether the UE has sufficient transmit power headroom to use a power control parameter associated with payloads carrying both of first UCI and second UCI, a payload based at least in part on a scheduled transmission of first UCI associated with a first priority level and second UCI associated with a second priority level different than the first priority level. For example, the UE (e.g., using generation component 1008, depicted in FIG. 10) may generate, if the UE has sufficient transmit power headroom to use a power control parameter associated with payloads carrying both of first UCI and second UCI, a payload carrying first UCI associated with a first priority level and second UCI associated with a second priority level different than the first priority level, as described above in connection with, for example, FIG. 5 at 520. If the UE does not have sufficient transmit power headroom to use the power control parameter for the uplink control channel communication, at least part of a UCI, of the first UCI and the second UCI, may be dropped based at least in part on comparing the first priority level and the second priority level. In some aspects, generating the payload further comprises generating the payload including the first UCI and at least a part of the second UCI, wherein the at least a part of the second UCI comprises one or more bits of the second UCI or a compressed version of the second UCI.

At 830, the UE may transmit an uplink control channel communication carrying the payload using the power control parameter associated with payloads carrying both of the first UCI and the second UCI, wherein the power control parameter is based at least in part on a size of the first UCI or a size of the second UCI. For example, the UE (e.g., using transmission component 1004, depicted in FIG. 10) may transmit an uplink control channel communication carrying the payload using the power control parameter associated with payloads carrying both of the first UCI and the second UCI, wherein the power control parameter is based at least in part on a size of the payload (e.g., the first UCI and/or the second UCI), as described above in connection with, for example, FIG. 5 and at 530.

Although FIG. 8 shows example blocks of method 800, in some aspects, method 800 may include additional blocks, fewer blocks, different blocks, or differently arranged blocks than those depicted in FIG. 8. Additionally, or alternatively, two or more of the blocks of method 800 may be performed in parallel.

FIG. 9 is a flowchart of an example method 900 of wireless communication. The method 900 may be performed by, for example, a network entity such as a base station (e.g., base station 110), a CU, a DU, or an RU.

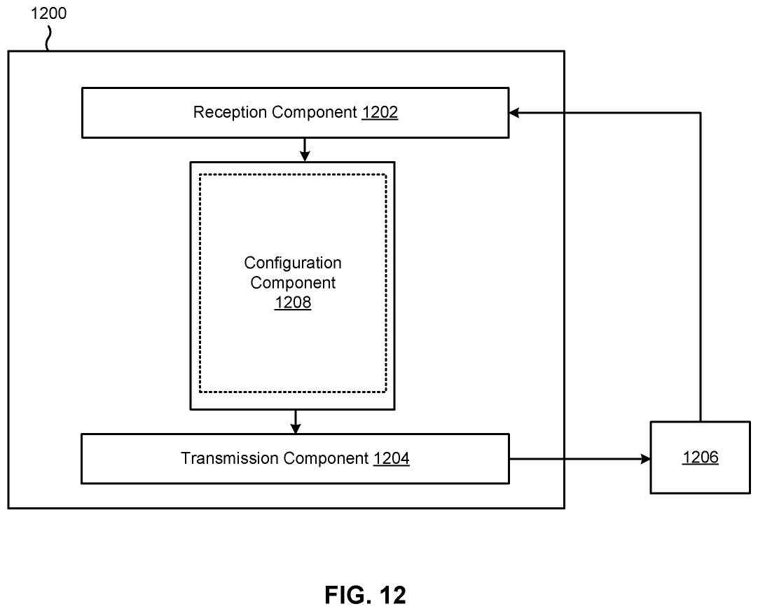

At 910, the network entity may configure a UE with a power control parameter for a payload based at least in part on a scheduled transmission of first UCI associated with a first priority level and second UCI associated with a second priority level different than the first priority level, wherein the power control parameter is based at least in part on a size of the first UCI or a size of the second UCI. For example, the base station (e.g., using configuration component 1208, depicted in FIG. 12) may configure a UE with a power control parameter for a payload based at least in part on a scheduled transmission of first UCI associated with a first priority level and second UCI associated with a second priority level different than the first priority level, wherein the power control parameter is based at least in part on a size of the first UCI or a size of the second UCI, as described above in connection with, for example, FIGS. 4, 5, and 6 and at 410, 510, and 610.

In some aspects, the power control parameter indicates a power boost for the uplink control channel communication relative to a baseline transmit power for the uplink control channel communication based at least in part on the size of the payload. In some aspects, the payload is in a resource block associated with the first UCI, and wherein the power control parameter is based at least in part on a power level associated with the first UCI and a size of the second UCI. In some aspects, the power control parameter indicates a first power boost if the second UCI has a first size and a second power boost if the second UCI has a second size. In some aspects, the first UCI is a scheduling request, the second UCI is HARQ feedback, and the first priority level is higher than the second priority level. In some aspects, the first UCI is HARQ feedback, the second UCI is a scheduling request, and the first priority level is higher than the second priority level.

In some aspects, the payload carrying the first UCI and the second UCI is based at least in part on the UE having sufficient transmit power headroom to use the power control parameter for the uplink control channel communication. In some aspects, if the UE does not have sufficient transmit power headroom to use the power control parameter for the uplink control channel communication, at least part of a UCI, of the first UCI and the second UCI, is dropped based at least in part on comparing the first priority level and the second priority level. In some aspects, the payload includes the first UCI and at least a part of the second UCI, wherein the at least a part of the second UCI comprises one or more bits of the second UCI or a compressed version of the second UCI. In some aspects, method 900 includes transmitting signaling (such as at 910) indicating whether to drop part of the second UCI to form the one or more bits or to compress the second UCI to form the compressed version of the second UCI. In some aspects, method 900 includes transmitting signaling (such as at 910) indicating whether to generate the payload by dropping part of the second UCI to form the one or more bits, compressing the second UCI to form the compressed version of the second UCI, or multiplexing the first UCI and the second UCI.

At 920, the base station may receive an uplink control channel communication carrying the payload. For example, the base station (e.g., using reception component 1202, depicted in FIG. 12) may receive an uplink control channel communication from the UE carrying the payload, as described above in connection with, for example, FIGS. 4, 5, and 6 and at 430, 530, and 640. In some aspects, the uplink control channel communication is associated with a short control channel format.

At 930, the base station may perform a communication based at least in part on the uplink control channel communication. For example, the base station may retransmit a communication, may schedule a resource for an uplink transmission of the UE, or the like.

Although FIG. 9 shows example blocks of method 900, in some aspects, method 900 may include additional blocks, fewer blocks, different blocks, or differently arranged blocks than those depicted in FIG. 9. Additionally, or alternatively, two or more of the blocks of method 900 may be performed in parallel.

FIG. 10 is a block diagram of an example apparatus 1000 for wireless communication, in accordance with the present disclosure. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include a generation component 1008, among other examples.

In some aspects, the apparatus 1000 may be configured to perform one or more operations described herein in connection with FIGS. 3-6. Additionally, or alternatively, the apparatus 1000 may be configured to perform one or more processes described herein, such as method 700 of FIG. 7, method 800 of FIG. 8, or a combination thereof. In some aspects, the apparatus 1000 and/or one or more components shown in FIG. 10 may include one or more components of the UE described above in connection with FIG. 2.

Additionally, or alternatively, one or more components shown in FIG. 10 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1006. In some aspects, the reception component 1002 may include one or more antennas, a demodulator, a MIMO detector, a receive processor, a controller/processor, a memory, or a combination thereof, of the UE described above in connection with FIG. 2.

The transmission component 1004 may transmit communications, such as reference signals, control information, data communications, or a combination thereof, to the apparatus 1006. In some aspects, one or more other components of the apparatus 1006 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modulator, a transmit MIMO processor, a transmit processor, a controller/processor, a memory, or a combination thereof, of the UE described above in connection with FIG. 2. In some aspects, the transmission component 1004 may be co-located with the reception component 1002 in a transceiver.

The generation component 1008 may generate a payload carrying first UCI associated with a first priority level and second UCI associated with a second priority level different than the first priority level. The transmission component 1004 may transmit an uplink control channel communication carrying the payload using a power control parameter associated with the payload carrying both of the first UCI and the second UCI, wherein the power control parameter is based at least in part on a size of the payload. The reception component 1002 may receive signaling indicating whether to drop part of the second UCI to form the one or more bits or to compress the second UCI to form the compressed version of the second UCI. The reception component 1002 may receive signaling indicating whether to generate the payload by dropping part of the second UCI to form the one or more bits, compressing the second UCI to form the compressed version of the second UCI, or multiplexing the first UCI and the second UCI. The reception component 1002 may receive information indicating the power control parameter.

The generation component 1008 may generate, if the UE has sufficient transmit power headroom to use a power control parameter associated with payloads carrying both of first UCI and second UCI, a payload carrying first UCI associated with a first priority level and second UCI associated with a second priority level different than the first priority level. The transmission component 1004 may transmit an uplink control channel communication carrying the payload using the power control parameter associated with payloads carrying both of the first UCI and the second UCI, wherein the power control parameter is based at least in part on a size of the payload.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

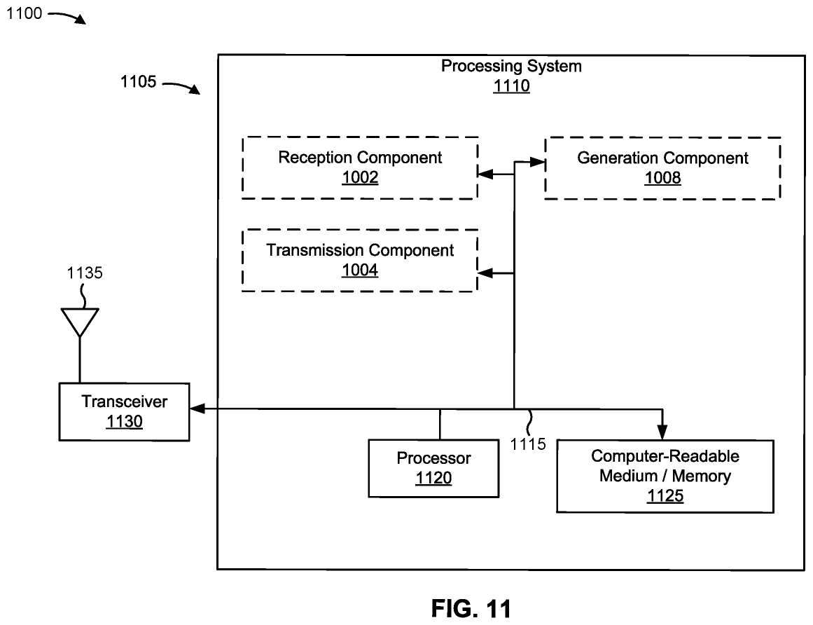

FIG. 11 is a diagram illustrating an example 1100 of a hardware implementation for an apparatus 1105 employing a processing system 1110, in accordance with the present disclosure. The apparatus 1105 may be a UE.

The processing system 1110 may be implemented with a bus architecture, represented generally by the bus 1115. The bus 1115 may include any number of interconnecting buses and bridges depending on the specific application of the processing system 1110 and the overall design constraints. The bus 1115 links together various circuits including one or more processors and/or hardware components, represented by the processor 1120, the illustrated components, and the computer-readable medium/memory 1125. The bus 1115 may also link various other circuits, such as timing sources, peripherals, voltage regulators, and/or power management circuits.

The processing system 1110 may be coupled to a transceiver 1130. The transceiver 1130 is coupled to one or more antennas 1135. The transceiver 1130 provides a means for communicating with various other apparatuses over a transmission medium. The transceiver 1130 receives a signal from the one or more antennas 1135, extracts information from the received signal, and provides the extracted information to the processing system 1110, specifically the reception component 1002. In addition, the transceiver 1130 receives information from the processing system 1110, specifically the transmission component 1004, and generates a signal to be applied to the one or more antennas 1135 based at least in part on the received information.

The processing system 1110 includes a processor 1120 coupled to a computer-readable medium/memory 1125. The processor 1120 is responsible for general processing, including the execution of software stored on the computer-readable medium/memory 1125. The software, when executed by the processor 1120, causes the processing system 1110 to perform the various functions described herein for any particular apparatus. The computer-readable medium/memory 1125 may also be used for storing data that is manipulated by the processor 1120 when executing software. The processing system further includes at least one of the illustrated components. The components may be software modules running in the processor 1120, resident/stored in the computer readable medium/memory 1125, one or more hardware modules coupled to the processor 1120, or some combination thereof.

In some aspects, the processing system 1110 may be a component of the UE 120 and may include the memory 282 and/or at least one of the TX MIMO processor 266, the RX processor 258, and/or the controller/processor 280. In some aspects, the apparatus 1105 for wireless communication includes means for generating a payload carrying first UCI associated with a first priority level and second UCI associated with a second priority level different than the first priority level; means for transmitting an uplink control channel communication carrying the payload using a power control parameter associated with the payload carrying both of the first UCI and the second UCI, wherein the power control parameter is based at least in part on a size of the payload; means for generating the payload including the first UCI and at least a part of the second UCI, wherein the at least a part of the second UCI comprises one or more bits of the second UCI or a compressed version of the second UCI; means for receiving signaling indicating whether to generate the payload by dropping part of the second UCI to form the one or more bits, compressing the second UCI to form the compressed version of the second UCI, or multiplexing the first UCI and the second UCI; means for receiving information indicating the power control parameter; means for generating, if the UE has sufficient transmit power headroom to use a power control parameter associated with payloads carrying both of first UCI and second UCI, a payload carrying first UCI associated with a first priority level and second UCI associated with a second priority level different than the first priority level; means for transmitting an uplink control channel communication carrying the payload using the power control parameter associated with payloads carrying both of the first UCI and the second UCI, wherein the power control parameter is based at least in part on a size of the payload; means for generating the payload including the first UCI and at least a part of the second UCI, wherein the at least a part of the second UCI comprises one or more bits of the second UCI or a compressed version of the second UCI. The aforementioned means may be one or more of the aforementioned components of the apparatus 1000 and/or the processing system 1110 of the apparatus 1105 configured to perform the functions recited by the aforementioned means. As described elsewhere herein, the processing system 1110 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 11 is provided as an example. Other examples may differ from what is described in connection with FIG. 11.

FIG. 12 is a block diagram of an example apparatus 1200 for wireless communication, in accordance with the present disclosure. The apparatus 1200 may be a network entity, or a network entity may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include a configuration component 1208, among other examples.

In some aspects, the apparatus 1200 may be configured to perform one or more operations described herein in connection with FIGS. 3-6. Additionally, or alternatively, the apparatus 1200 may be configured to perform one or more processes described herein, such as method 900 of FIG. 9, or a combination thereof. In some aspects, the apparatus 1200 and/or one or more components shown in FIG. 12 may include one or more components of the base station described above in connection with FIG. 2. Additionally, or alternatively, one or more components shown in FIG. 12 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1206. In some aspects, the reception component 1202 may include one or more antennas, a demodulator, a MIMO detector, a receive processor, a controller/processor, a memory, or a combination thereof, of the base station described above in connection with FIG. 2.

The transmission component 1204 may transmit communications, such as reference signals, control information, data communications, or a combination thereof, to the apparatus 1206. In some aspects, one or more other components of the apparatus 1206 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modulator, a transmit MIMO processor, a transmit processor, a controller/processor, a memory, or a combination thereof, of the base station described above in connection with FIG. 2. In some aspects, the transmission component 1204 may be co-located with the reception component 1202 in a transceiver.

The configuration component 1208 may configure, or may cause the transmission component 1204 to configure, a UE with a power control parameter for a payload carrying first UCI associated with a first priority level and second UCI associated with a second priority level different than the first priority level, wherein the power control parameter is based at least in part on a size of the payload. The reception component 1202 may receive an uplink control channel communication from the UE carrying the payload. In some aspects, The transmission component 1204 or the configuration component 1208 may transmit signaling indicating whether to drop part of the second UCI to form the one or more bits or to compress the second UCI to form the compressed version of the second UCI. In some aspects, the transmission component 1204 or the configuration component 1208 may transmit signaling indicating whether to generate the payload by dropping part of the second UCI to form the one or more bits, compressing the second UCI to form the compressed version of the second UCI, or multiplexing the first UCI and the second UCI.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

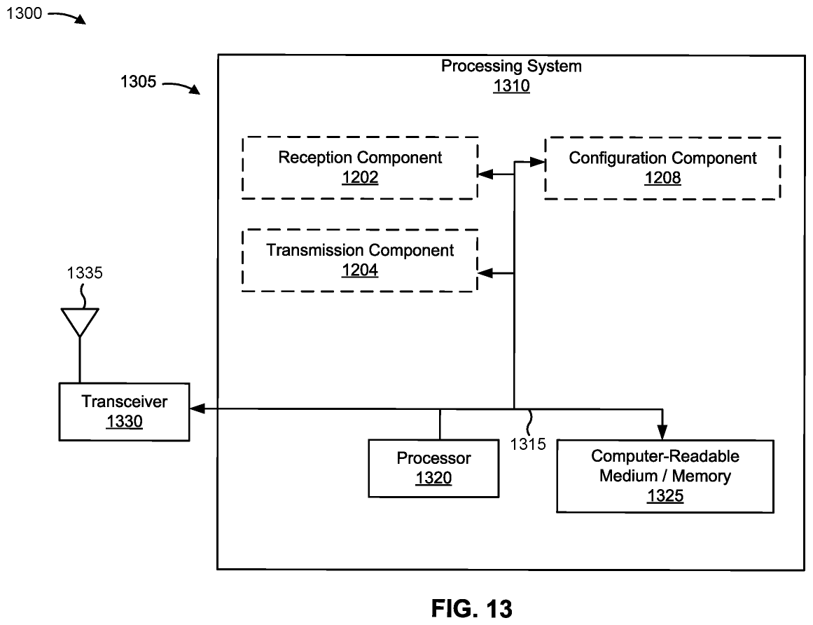

FIG. 13 is a diagram illustrating an example 1300 of a hardware implementation for an apparatus 1305 employing a processing system 1310, in accordance with the present disclosure. The apparatus 1305 may be a network entity.

The processing system 1310 may be implemented with a bus architecture, represented generally by the bus 1315. The bus 1315 may include any number of interconnecting buses and bridges depending on the specific application of the processing system 1310 and the overall design constraints. The bus 1315 links together various circuits including one or more processors and/or hardware components, represented by the processor 1320, the illustrated components, and the computer-readable medium/memory 1325. The bus 1315 may also link various other circuits, such as timing sources, peripherals, voltage regulators, and/or power management circuits.

The processing system 1310 may be coupled to a transceiver 1330. The transceiver 1330 is coupled to one or more antennas 1335. The transceiver 1330 provides a means for communicating with various other apparatuses over a transmission medium. The transceiver 1330 receives a signal from the one or more antennas 1335, extracts information from the received signal, and provides the extracted information to the processing system 1310, specifically the reception component 1202. In addition, the transceiver 1330 receives information from the processing system 1310, specifically the transmission component 1204, and generates a signal to be applied to the one or more antennas 1335 based at least in part on the received information.

The processing system 1310 includes a processor 1320 coupled to a computer-readable medium/memory 1325. The processor 1320 is responsible for general processing, including the execution of software stored on the computer-readable medium/memory 1325. The software, when executed by the processor 1320, causes the processing system 1310 to perform the various functions described herein for any particular apparatus. The computer-readable medium/memory 1325 may also be used for storing data that is manipulated by the processor 1320 when executing software. The processing system further includes at least one of the illustrated components. The components may be software modules running in the processor 1320, resident/stored in the computer readable medium/memory 1325, one or more hardware modules coupled to the processor 1320, or some combination thereof.

In some aspects, the processing system 1310 may be a component of the UE 120 and may include the memory 282 and/or at least one of the TX MIMO processor 266, the RX processor 258, and/or the controller/processor 280. In some aspects, the apparatus 1305 for wireless communication includes means for configuring a UE with a power control parameter for a payload carrying first UCI associated with a first priority level and second UCI associated with a second priority level different than the first priority level, wherein the power control parameter is based at least in part on a size of the payload; and means for receiving an uplink control channel communication from the UE carrying the payload. The aforementioned means may be one or more of the aforementioned components of the apparatus 1200 and/or the processing system 1310 of the apparatus 1305 configured to perform the functions recited by the aforementioned means. As described elsewhere herein, the processing system 1310 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

In some aspects, the processing system 1310 may be a component of the base station 110 and may include the memory 242 and/or at least one of the TX MIMO processor 230, the RX processor 238, and/or the controller/processor 240. In some aspects, the apparatus 1305 for wireless communication includes means for configuring a UE with a power control parameter for a payload carrying first UCI associated with a first priority level and second UCI associated with a second priority level different than the first priority level, wherein the power control parameter is based at least in part on a size of the payload, means for receiving an uplink control channel communication from the UE carrying the payload, means for transmitting signaling indicating whether to drop part of the second UCI to form the one or more bits or to compress the second UCI to form the compressed version of the second UCI, and means for transmitting signaling indicating whether to generate the payload by dropping part of the second UCI to form the one or more bits, compressing the second UCI to form the compressed version of the second UCI, or multiplexing the first UCI and the second UCI. The aforementioned means may be one or more of the aforementioned components of the apparatus 1200 and/or the processing system 1310 of the apparatus 1305 configured to perform the functions recited by the aforementioned means. As described elsewhere herein, the processing system 1310 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 13 is provided as an example. Other examples may differ from what is described in connection with FIG. 13.

The following provides an overview of some Aspects of the present disclosure:

Aspect 1: A method of wireless communication performed by a user equipment (UE), comprising: generating a payload based at least in part on a scheduled transmission of first uplink control information (UCI) associated with a first priority level and second UCI associated with a second priority level different than the first priority level; and transmitting an uplink control channel communication carrying the payload using a power control parameter associated with the payload carrying both of the first UCI and the second UCI, wherein the power control parameter is based at least in part on a size of the first UCI or a size of the second UCI.

Aspect 2: The method of Aspect 1, wherein the power control parameter indicates a power boost for the uplink control channel communication relative to a baseline transmit power for the uplink control channel communication based at least in part on the size of the first UCI or the second UCI.

Aspect 3: The method of any of Aspects 1-2, wherein the payload is transmitted in a resource block associated with the first UCI, and wherein the power control parameter is based at least in part on a power level associated with the first UCI and the size of the second UCI.

Aspect 4: The method of any of Aspects 1-3, wherein the power control parameter indicates a first power boost if the second UCI has a first size and a second power boost if the second UCI has a second size.

Aspect 5: The method of any of Aspects 1-4, wherein the first UCI is a scheduling request, the second UCI is hybrid automatic repeat request (HARQ) feedback, and the first priority level is higher than the second priority level.

Aspect 6: The method of any of Aspects 1-4, wherein the first UCI is hybrid automatic repeat request (HARQ) feedback, the second UCI is a scheduling request, and the first priority level is higher than the second priority level.

Aspect 7: The method of any of Aspects 1-6, wherein the uplink control channel is associated with a short control channel format.

Aspect 8: The method of any of Aspects 1-7, wherein the payload carries the first UCI and the second UCI based at least in part on the UE having sufficient transmit power headroom to use the power control parameter for the uplink control channel communication.

Aspect 9: The method of any of Aspects 1-8, wherein, if the UE does not have sufficient transmit power headroom to use the power control parameter for the uplink control channel communication, at least part of a UCI, of the first UCI and the second UCI, is dropped based at least in part on comparing the first priority level and the second priority level.

Aspect 10: The method of Aspect 9, wherein generating the payload further comprises: generating the payload including the first UCI and at least a part of the second UCI, wherein the at least a part of the second UCI comprises one or more bits of the second UCI or a compressed version of the second UCI.

Aspect 11: The method of Aspect 10, further comprising: receiving signaling indicating whether to drop part of the second UCI to form the one or more bits or to compress the second UCI to form the compressed version of the second UCI.

Aspect 12: The method of Aspect 10, further comprising: receiving signaling indicating whether to generate the payload by dropping part of the second UCI to form the one or more bits, compressing the second UCI to form the compressed version of the second UCI, or multiplexing the first UCI and the second UCI.

Aspect 13: The method of any of Aspects 1-12, further comprising: receiving information indicating the power control parameter.

Aspect 14: A method of wireless communication performed by a user equipment (UE), comprising: generating, based at least in part on whether the UE has sufficient transmit power headroom to use a power control parameter associated with payloads carrying both of first uplink control information (UCI) and second UCI, a payload based at least in part on a scheduled transmission of first UCI associated with a first priority level and second UCI associated with a second priority level different than the first priority level; and transmitting an uplink control channel communication carrying the payload using the power control parameter associated with payloads carrying both of the first UCI and the second UCI, wherein the power control parameter is based at least in part on a size of the first UCI or a size of the second UCI.

Aspect 15: The method of Aspect 14, wherein, if the UE does not have sufficient transmit power headroom to use the power control parameter for the uplink control channel communication, at least part of a UCI, of the first UCI and the second UCI, is dropped based at least in part on comparing the first priority level and the second priority level.

Aspect 16: The method of Aspect 15, wherein generating the payload further comprises: generating the payload including the first UCI and at least a part of the second UCI, wherein the at least a part of the second UCI comprises one or more bits of the second UCI or a compressed version of the second UCI.

Aspect 17: A method of wireless communication performed by a network entity, comprising: configuring a user equipment (UE) with a power control parameter for a payload based at least in part on a scheduled transmission of first uplink control information (UCI) associated with a first priority level and second UCI associated with a second priority level different than the first priority level, wherein the power control parameter is based at least in part on a size of the first UCI or a size of the second UCI; and receiving an uplink control channel communication carrying the payload.

Aspect 18: The method of Aspect 17, wherein the power control parameter indicates a power boost for the uplink control channel communication relative to a baseline transmit power for the uplink control channel communication based at least in part on the size of the first UCI or the size of the second UCI.

Aspect 19: The method of any of Aspects 17-18, wherein the payload is in a resource block associated with the first UCI, and wherein the power control parameter is based at least in part on a power level associated with the first UCI and the size of the second UCI.

Aspect 20: The method of Aspect 19, wherein the power control parameter indicates a first power boost if the second UCI has a first size and a second power boost if the second UCI has a second size.

Aspect 21: The method of any of Aspects 17-20, wherein the first UCI is a scheduling request, the second UCI is hybrid automatic repeat request (HARQ) feedback, and the first priority level is higher than the second priority level.

Aspect 22: The method of any of Aspects 17-20, wherein the first UCI is hybrid automatic repeat request (HARQ) feedback, the second UCI is a scheduling request, and the first priority level is higher than the second priority level.

Aspect 23: The method of any of Aspects 17-22, wherein the uplink control channel communication is associated with a short control channel format.

Aspect 24: The method of any of Aspects 17-23, wherein the payload carries the first UCI and the second UCI based at least in part on the UE having sufficient transmit power headroom to use the power control parameter for the uplink control channel communication.

Aspect 25: The method of any of Aspects 17-24, wherein, if the UE does not have sufficient transmit power headroom to use the power control parameter for the uplink control channel communication, at least part of a UCI, of the first UCI and the second UCI, is dropped based at least in part on comparing the first priority level and the second priority level.

Aspect 26: The method of Aspect 25, wherein the payload includes the first UCI and at least a part of the second UCI, wherein the at least a part of the second UCI comprises one or more bits of the second UCI or a compressed version of the second UCI.

Aspect 27: The method of Aspect 26, further comprising: transmitting signaling indicating whether to drop part of the second UCI to form the one or more bits or to compress the second UCI to form the compressed version of the second UCI.

Aspect 28: The method of Aspect 26, further comprising: transmitting signaling indicating whether to generate the payload by dropping part of the second UCI to form the one or more bits, compressing the second UCI to form the compressed version of the second UCI, or multiplexing the first UCI and the second UCI.

Aspect 29: An apparatus for wireless communication at a device, comprising a processor; memory coupled with the processor; and instructions stored in the memory and executable by the processor to cause the apparatus to perform the method of one or more of Aspects 1-28.

Aspect 30: A device for wireless communication, comprising a memory and one or more processors coupled to the memory, the one or more processors configured to perform the method of one or more of Aspects 1-28.

Aspect 31: An apparatus for wireless communication, comprising at least one means for performing the method of one or more of Aspects 1-28.

Aspect 32: A non-transitory computer-readable medium storing code for wireless communication, the code comprising instructions executable by a processor to perform the method of one or more of Aspects 1-28.

Aspect 33: A non-transitory computer-readable medium storing a set of instructions for wireless communication, the set of instructions comprising one or more instructions that, when executed by one or more processors of a device, cause the device to perform the method of one or more of Aspects 1-28.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
generate a payload based at least in part on a scheduled transmission of first uplink control information (UCI) associated with a first priority level and second UCI associated with a second priority level different than the first priority level; and
transmit an uplink control channel communication carrying the payload using a power control parameter associated with the payload carrying both of the first UCI and the second UCI, wherein the power control parameter is based at least in part on a size of the first UCI or a size of the second UCI.

2. The apparatus of claim 1, wherein the power control parameter indicates a power boost for the uplink control channel communication relative to a baseline transmit power for the uplink control channel communication based at least in part on the size of the first UCI or the second UCI.

3. The apparatus of claim 1, wherein the payload is transmitted in a resource block associated with the first UCI, and wherein the power control parameter is based at least in part on a power level associated with the first UCI and the size of the second UCI.

4. The apparatus of claim 1, wherein the power control parameter indicates a first power boost if the second UCI has a first size and a second power boost if the second UCI has a second size.

5. The apparatus of claim 1, wherein the first UCI is a scheduling request, the second UCI is hybrid automatic repeat request (HARQ) feedback, and the first priority level is higher than the second priority level.

6. The apparatus of claim 1, wherein the first UCI is hybrid automatic repeat request (HARQ) feedback, the second UCI is a scheduling request, and the first priority level is higher than the second priority level.

7. The apparatus of claim 1, wherein the uplink control channel is associated with a short control channel format.

8. The apparatus of claim 1, wherein the payload carries the first UCI and the second UCI based at least in part on the UE having sufficient transmit power headroom to use the power control parameter for the uplink control channel communication.

9. The apparatus of claim 1, wherein, if the UE does not have sufficient transmit power headroom to use the power control parameter for the uplink control channel communication, at least part of a UCI, of the first UCI and the second UCI, is dropped based at least in part on comparing the first priority level and the second priority level.

10. The apparatus of claim 9, wherein the one or more processors, to generate the payload, are configured to:
generate the payload including the first UCI and at least a part of the second UCI, wherein the at least a part of the second UCI comprises one or more bits of the second UCI or a compressed version of the second UCI.

11. The apparatus of claim 10, wherein the one or more processors are further configured to:
receive signaling indicating whether to drop part of the second UCI to form the one or more bits or to compress the second UCI to form the compressed version of the second UCI.

12. The apparatus of claim 10, wherein the one or more processors are further configured to:
receive signaling indicating whether to generate the payload by dropping part of the second UCI to form the one or more bits, compressing the second UCI to form the compressed version of the second UCI, or multiplexing the first UCI and the second UCI.

13. The apparatus of claim 1, wherein the one or more processors are further configured to:
receive information indicating the power control parameter.

14. An apparatus for wireless communication at an UE, comprising:
a memory; and
one or more processors, coupled to the memory, configured to:
generate, based at least in part on whether the UE has sufficient transmit power headroom to use a power control parameter associated with payloads carrying both of first uplink control information (UCI) and second UCI, a payload based at least in part on a scheduled transmission of first UCI associated with a first priority level and second UCI associated with a second priority level different than the first priority level; and
transmit an uplink control channel communication carrying the payload using the power control parameter associated with payloads carrying both of the first UCI and the second UCI, wherein the power control parameter is based at least in part on a size of the first UCI or a size of the second UCI.

15. The apparatus of claim 14, wherein, if the UE does not have sufficient transmit power headroom to use the power control parameter for the uplink control channel communication, at least part of a UCI, of the first UCI and the second UCI, is dropped based at least in part on comparing the first priority level and the second priority level.

16. The apparatus of claim 15, wherein the one or more processors, to generate the payload, are configured to:
generate the payload including the first UCI and at least a part of the second UCI, wherein the at least a part of the second UCI comprises one or more bits of the second UCI or a compressed version of the second UCI.

17. An apparatus for wireless communication at a network entity, comprising:
a memory; and
one or more processors, coupled to the memory, configured to:
configure a user equipment (UE) with a power control parameter for a payload based at least in part on a scheduled transmission of first uplink control information (UCI) associated with a first priority level and second UCI associated with a second priority level different than the first priority level, wherein the power control parameter is based at least in part on a size of the first UCI or a size of the second UCI; and
receive an uplink control channel communication carrying the payload.

18. The apparatus of claim 17, wherein the power control parameter indicates a power boost for the uplink control channel communication relative to a baseline transmit power for the uplink control channel communication based at least in part on the size of the first UCI or the size of the second UCI.

19. The apparatus of claim 17, wherein the payload is in a resource block associated with the first UCI, and wherein the power control parameter is based at least in part on a power level associated with the first UCI and the size of the second UCI.

20. The apparatus of claim 19, wherein the power control parameter indicates a first power boost if the second UCI has a first size and a second power boost if the second UCI has a second size.

21. The apparatus of claim 17, wherein the first UCI is a scheduling request, the second UCI is hybrid automatic repeat request (HARQ) feedback, and the first priority level is higher than the second priority level.

22. The apparatus of claim 17, wherein the first UCI is hybrid automatic repeat request (HARQ) feedback, the second UCI is a scheduling request, and the first priority level is higher than the second priority level.

23. The apparatus of claim 17, wherein the uplink control channel communication is associated with a short control channel format.

24. The apparatus of claim 17, wherein the payload carries the first UCI and the second UCI based at least in part on the UE having sufficient transmit power headroom to use the power control parameter for the uplink control channel communication.

25. The apparatus of claim 17, wherein, if the UE does not have sufficient transmit power headroom to use the power control parameter for the uplink control channel communication, at least part of a UCI, of the first UCI and the second UCI, is dropped based at least in part on comparing the first priority level and the second priority level.

26. The apparatus of claim 25, wherein the payload includes the first UCI and at least a part of the second UCI, wherein the at least a part of the second UCI comprises one or more bits of the second UCI or a compressed version of the second UCI.

27. The apparatus of claim 26, wherein the one or more processors are further configured to:
transmit signaling indicating whether to drop part of the second UCI to form the one or more bits or to compress the second UCI to form the compressed version of the second UCI.

28. The apparatus of claim 26, wherein the one or more processors are further configured to:
transmit signaling indicating whether to generate the payload by dropping part of the second UCI to form the one or more bits, compressing the second UCI to form the compressed version of the second UCI, or multiplexing the first UCI and the second UCI.

29. A method of wireless communication performed by a user equipment (UE), comprising:
generating a payload based at least in part on a scheduled transmission of first uplink control information (UCI) associated with a first priority level and second UCI associated with a second priority level different than the first priority level; and
transmitting an uplink control channel communication carrying the payload using a power control parameter associated with the payload carrying both of the first UCI and the second UCI, wherein the power control parameter is based at least in part on a size of the first UCI or a size of the second UCI.

30. The method of claim 1, wherein the power control parameter indicates a power boost for the uplink control channel communication relative to a baseline transmit power for the uplink control channel communication based at least in part on the size of the first UCI or the second UCI.
